(19) United States
(12) Patent Application Publication
(10) Pub. No.: US 2026/0199177 A1
(43) Pub. Date: Jul. 16, 2026

(54) MULTI-VALVE MULTI-AIRBAG MASSAGE EQUIPMENT

(71) Applicant: TFC Technology Co., Ltd., Jiaxing (CN)

(72) Inventors: Jun Cai, Jiaxing (CN); Ming Xu, Jiaxing (CN); Chuan Li, Jiaxing (CN); Fuyou Liu, Jiaxing (CN); Kangming Tao, Jiaxing (CN)

(21) Appl. No.: 19/560,327

(22) Filed: Mar. 9, 2026

(30) Foreign Application Priority Data
Feb. 13, 2026 (CN) 202610212710.3

(51) Int. Cl. A61H 9/00

(52) U.S. Cl. CPC A61H 9/0078; A61H 2201/0146; A61H 2201/0207; A61H 2201/1238; A61H 2201/169; A61H 2201/501; A61H 2201/5056

(57) ABSTRACT

Multi-valve multi-airbag massage equipment is provided, including a massage control system that includes a plurality of modules, and a mattress. A user command module is configured to generate a control command in response to a user operation. A signal receiving module is connected to the user command module to receive the control command. A control module generates a control signal based on the control command. An execution module includes an air pump, a control air path, and a plurality of massage airbag groups. The air pump performs start and stop operations after receiving the control signal. The control air path is connected or disconnected after receiving the control signal, to inflate or deflate the plurality of massage airbag groups. The plurality of massage airbag groups are respectively arranged above a position, corresponding to a bedside, on the mattress. The multi-valve multi-airbag massage equipment provides multi-mode massage and thermal therapy functions.

### TECHNICAL FIELD

The present disclosure relates to the field of massage beds, and in particular, to a multi-valve multi-airbag massage control system and massage equipment.

### BACKGROUND

Existing massage equipment, particularly massage beds, have some common shortcomings. 1. Most massage beds on the market use mechanical rollers to implement massage. Due to high hardness, massage devices of the massage beds apply a high pressure to a human body, leading to a poor massage experience. In addition, due to a single functional mode, the massage beds cannot meet personalized needs of users. 2. Some solutions employing airbag massage have a poor design in an airway system, which will generate significant airflow noise during inflation and deflation and affect the rest and relaxation experience of users. 3. Existing airbag massage beds typically only offer a single massage function, so that they lack therapies such as thermal therapy and are unable to provide users with comprehensive physical therapy and health care benefits.

### SUMMARY

For the shortcomings in the prior art, the present disclosure provides a multi-valve multi-airbag massage control system and massage equipment, which provide multi-mode massage, low-noise operation, and thermal therapy functions.

In order to achieve the above objective, the present disclosure provides the following technical solutions:

Multi-valve multi-airbag massage equipment includes a massage control system and a mattress.

The massage control system includes a user command module, a signal receiving module, a control module, and an execution module;

the user command module is configured to generate a control command in response to a user operation;

the signal receiving module is connected to the user command module to receive the control command;

the control module is connected to the signal receiving module and generates a control signal based on the control command;

the execution module includes an air pump, a control air path, and a plurality of massage airbag groups;

the air pump is connected to the control module and performs start and stop operations after receiving the control signal;

the control air path is connected to the control module and the plurality of massage airbag groups, and is connected or disconnected after receiving the control signal to inflate or deflate the plurality of massage airbag groups; and

the plurality of massage airbag groups are respectively arranged in the mattress and above a position, corresponding to a bedside, on the mattress.

Preferably, a plurality of massage airbag groups located in the mattress include a back airbag group, a waist airbag group, a hip airbag group, and a leg airbag group; a massage airbag group located above the position, corresponding to the bedside, on the mattress is a neck airbag group; and each airbag group includes a support pad, and a left airbag and a right airbag which are arranged on the support pad.

Preferably, a pillow is arranged above the position, corresponding to the bedside, on the mattress, and the neck airbag group is arranged in the pillow.

Preferably, a bottom airbag is arranged in each of the neck airbag group and the waist airbag group; and the bottom airbags are arranged below the left airbags and the right airbags.

Preferably, the waist airbag group further includes a middle airbag, and the middle airbag is arranged between the left airbags and the right airbags.

Preferably, the control air path includes an air path control box and a plurality of branch air paths connected to the air path control box;

the air path control box is connected to the air pump;

air inlet ends of the plurality of branch air paths are connected to the air path control box; and air outlet ends are correspondingly connected to the plurality of massage airbag groups respectively.

Preferably, the massage control system further includes a silencing module; the silencing module includes a silencing box and a silencing nozzle; the silencing box is arranged at an air outlet of the air pump; and the silencing nozzle is arranged at air inlets of the massage airbag groups.

Preferably, the massage control system further includes a thermal therapy module; and the thermal therapy module is connected to the control module and includes a waist heating pad and a foot heating pad.

Preferably, the mattress includes an upper layer, a middle layer, and a lower layer; the middle layer has memory foam and support sponge which are distributed vertically; the back airbag group, the waist airbag group, the hip airbag group, and the leg airbag group are arranged below the memory foam.

Preferably, a groove is formed in a lower surface of the memory foam; and an air pipe in the control air path is arranged in the groove.

The present disclosure has the advantages as follows:

1. By the arrangement of the plurality of independently controlled massage airbag groups, in conjunction with the user command module and the control module, precise and diverse massage modes can be implemented on different parts of a body, thereby various needs of users and providing a softer and more comfortable massage experience.

2. By using a dual silencing structure composed of the silencing box and the silencing nozzle, noise generated by airflow during transportation and release is effectively reduced, thus improving the quietness and comfort of use.

3. Integrating the thermal therapy module, namely the heating pads, into the massage mattress can implement thermal therapy on key areas such as the waist and the feet during massaging, thus implementing collaborative health care of massaging and thermal therapy and increasing the physical therapy and health care value of a product.

### BRIEF DESCRIPTION OF THE DRAWINGS

FIG. 1 is a schematic diagram of arrangement of a plurality of massage airbag groups in a bed body according to this embodiment;

FIG. 2 is a schematic diagram of an air path of a massage control system according to this embodiment;

FIG. 3 is a schematic diagram of a bed body according to this embodiment;

FIG. 4 is a cross-sectional view of a bed body according to this embodiment;

FIG. 5 is a top view of memory foam according to this embodiment;

FIG. 6 is a schematic diagram of a remote controller according to this embodiment;

FIG. 7 is a logic diagram of massage control according to this embodiment;

FIG. 8 is a schematic diagram of a silencing box according to this embodiment; and

FIG. 9 is a schematic diagram of a silencing nozzle according to this embodiment.

### DETAILED DESCRIPTION OF THE EMBODIMENTS

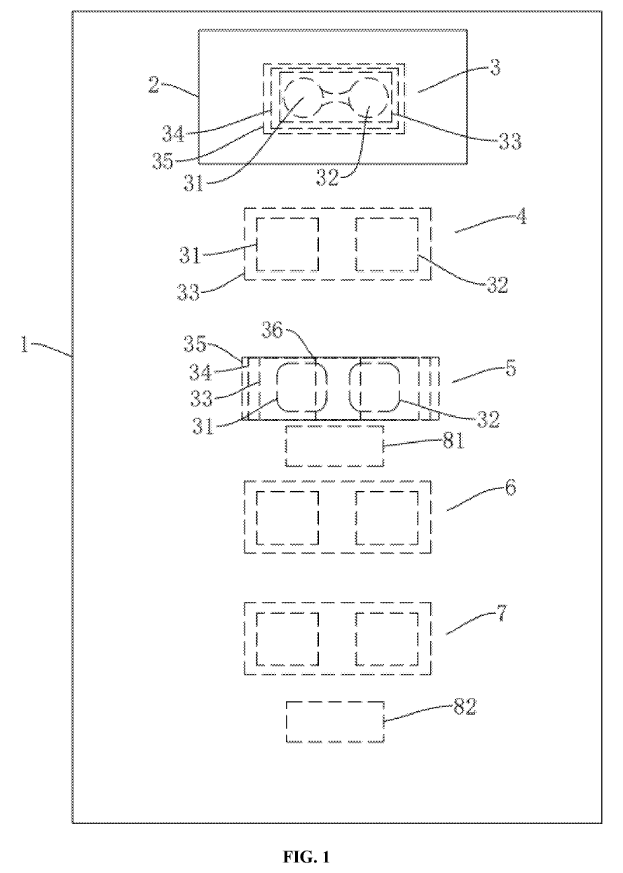

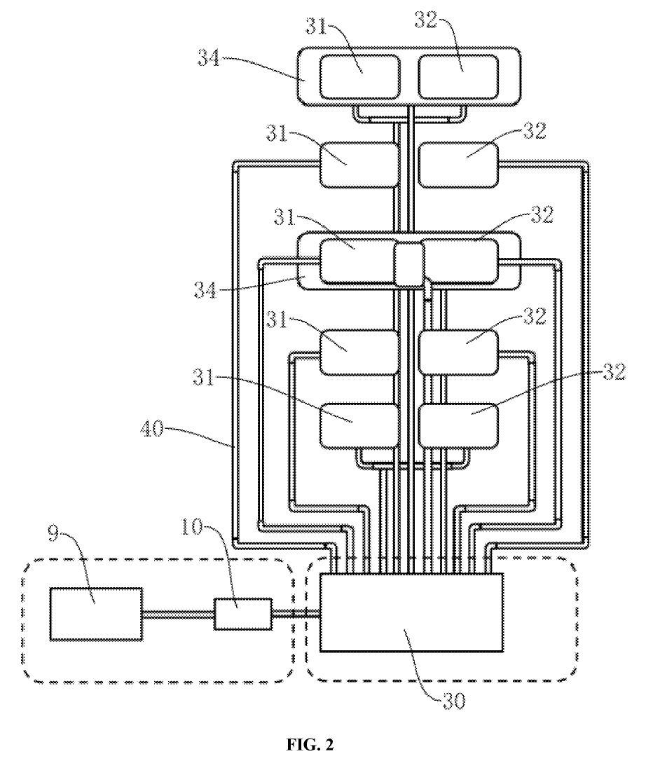

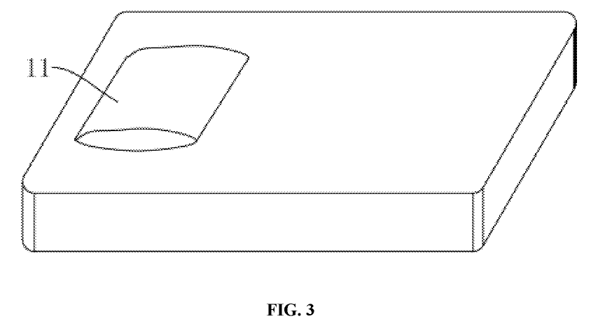

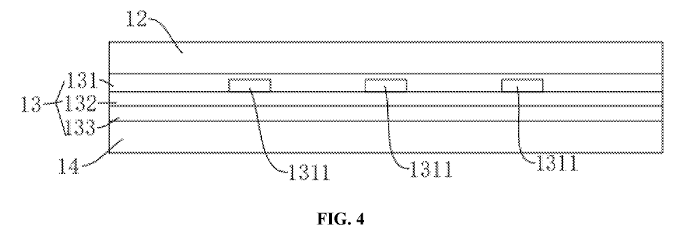

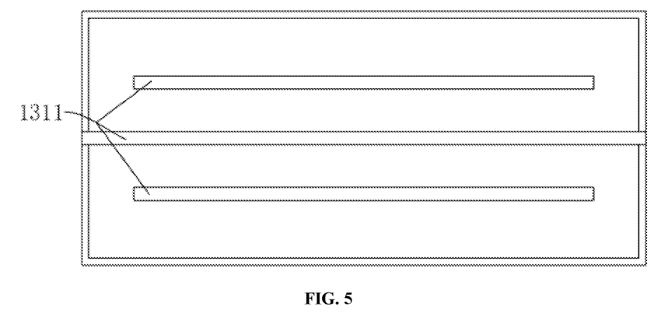

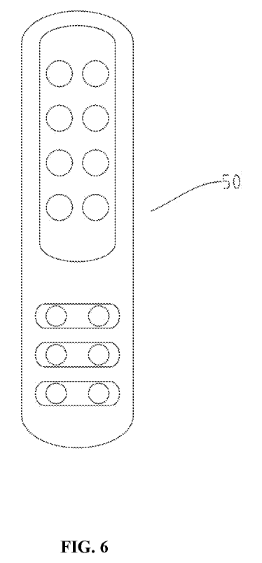

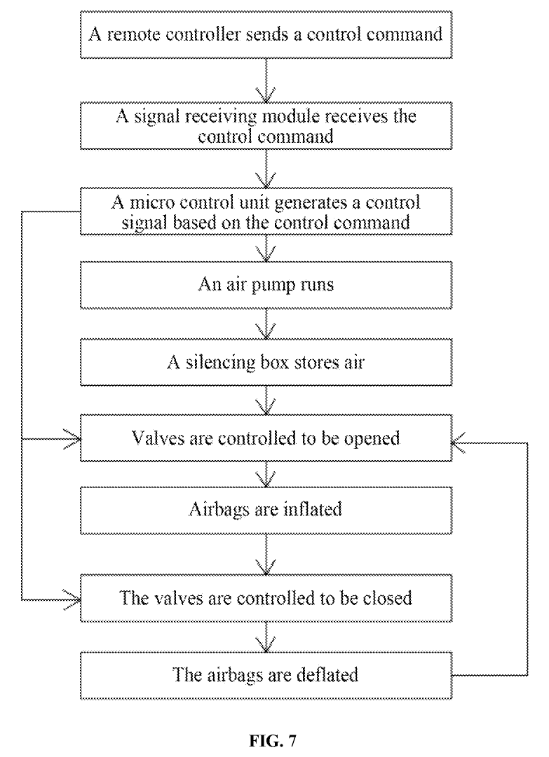

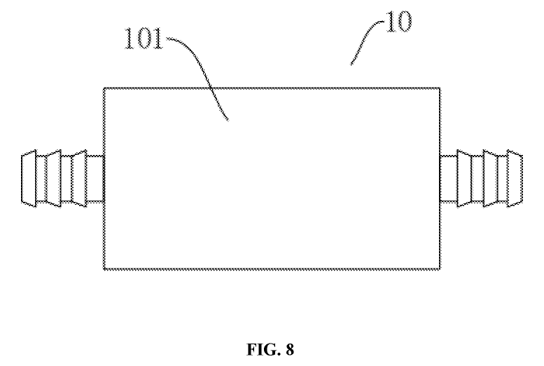

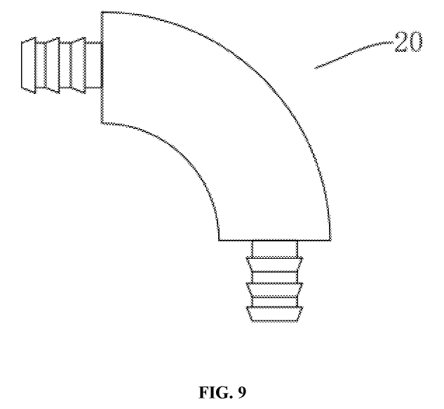

A further explanation of multi-valve multi-airbag massage equipment of the present disclosure is made in conjunction with FIG. 1 to FIG. 9.

Multi-valve multi-airbag massage equipment includes a massage control system and a mattress 1.

The massage control system includes a user command module, a signal receiving module, a control module, and an execution module.

The user command module is a remote controller 50, which is configured to generate a control command in response to a user operation and transmit the control command through a wireless module.

The signal receiving module is wirelessly connected to the user command module to receive the control command.

The control module is a micro control unit which is electrically connected to the signal receiving module and generates a control signal based on the control command and a preset program.

The execution module includes an air pump 9, a control air path, and a plurality of massage airbag groups.

The air pump 9 is connected to the control module and performs start and stop operations after receiving the control signal. The control air path is connected to the control module and the plurality of massage airbag groups, and is connected or disconnected after receiving the control signal to inflate or deflate the plurality of massage airbag groups. The plurality of massage airbag groups are respectively arranged in the mattress 1 and above a position, corresponding to a bedside, on the mattress 1.

Further, a plurality of massage airbag groups located in the mattress 1 are arranged in a front-back direction of the mattress 1 and include a back airbag group 4, a waist airbag group 5, a hip airbag group 6, and a leg airbag group 7. A massage airbag group located above the position, corresponding to the bedside, on the mattress 1 is a neck airbag group 3. Each airbag group includes a support pad 33, and a left airbag 31 and a right airbag 32 which are arranged on the support pad 33. The support pad 33 is a felt pad for fixing the left airbag 31 and the right airbag 32. That is, a connection sheet is provided between the left airbag 31 and the right airbag 32. The connection sheet is sutured with the felt pad to fix a relative position between the left airbag 31 and the right airbag 32, thus avoiding the problem of positional deviation during use. The felt pad is relatively hard and can play a role in supporting, so that the left airbag 31 and the right airbag 32 can protrude upwards after being inflated, to implement effective massaging. The left airbag 31 and the right airbag 32 are arranged separately, which can provide precise single-point massage and improve the massage comfort.

A pillow 2 is arranged above the position, corresponding to the bedside, on the mattress 1, and the neck airbag group 3 is arranged in the pillow 2. In this structure, a user can enjoy a neck massage effect while using the pillow 2.

A bottom airbag 34 is arranged in each of the neck airbag group 3 and the waist airbag group 5. The bottom airbags 34 are arranged below the left airbags 31 and the right airbags 32. That is, the bottom airbags 34 are located below the support pads 33 of the left airbags 31 and the right airbags 32. Meanwhile, lower support pads 35 are arranged below the bottom airbags 34. Edge positions of the lower support pads 35 and edge positions of the support pads 33 located above are sutured and positioned. When a user is in a normal lying position, the neck and the waist are generally in a suspended state. Therefore, the bottom airbags 34 can jack the left airbags 31 and the right airbags 32 to fit the neck and the waist. Then, the left airbags 31 and the right airbags 32 can be inflated and deflated to achieve precise single-point massage on two sides of the cervical vertebra of the neck and two sides of the lumbar vertebra of the waist.

The waist airbag group 5 further includes a middle airbag 36, and the middle airbag 36 is arranged between the left airbags 31 and the right airbags 32, to massage the lumbar vertebra of the waist.

The control air path includes an air path control box 30 and a plurality of branch air paths 40 connected to the air path control box 30.

The air path control box 30 has a plurality of valves. The valves are electromagnetic valves which are all connected to the control module. The plurality of valves are connected to the air pump 9 through a main air pipe. The branch air paths 40 are branch air pipes. Air inlet ends of the plurality of branch air paths 40 are correspondingly connected to the plurality of valves in the air path control box 30, and air outlet ends are correspondingly connected to the plurality of massage airbag groups respectively. The two bottom airbags 34 are also connected to independent branch air paths 40. During operation, the air pump 9 supplies air. By controlling opening or closing of the valves in the control box, the neck airbag group 3, the back airbag group 4, the waist airbag group 5, the hip airbag group 6, the leg airbag group 7, and the two bottom airbags 34 can be independently inflated or deflated to achieve a multifunctional massage effect.

Specifically, since the logic of neck massage and the logic of leg massage are the same, the left airbag 31 and the right airbag 32 in the neck airbag group 3 share the same branch air path 40, and the left airbag 31 and the right airbag 32 in the leg airbag group 7 also share the same branch air path 40, which can reduce the costs and facilitate control. The left airbags 31 and the right airbags 32 in other airbag groups and the two bottom airbags 34 use independent branch air paths 40. Therefore, in this embodiment, there are a total of 11 branch air paths 40 and 11 valves to achieve independent control, thereby achieving the multifunctional massage effect.

To enhance the quietness of use, the massage control system further includes a silencing module. The silencing module includes a silencing box 10 and a silencing nozzle 20. The silencing box 10 is arranged at an air outlet of the air pump 9. It is a swelled silencer of a hollow structure and is composed of a pipe and a cavity 101. A sudden change in sound resistance in a channel is caused by sudden expansion or contraction of a cross section of the pipe, so that sound waves that are transmitted along the pipeline and have some frequencies do not pass through the silencer and are reflected back to a sound source, thus achieving silencing. Then, the space is enlarged because of a cavity structure, so that voltage storage and current stabilization effects can be achieved. An air inlet end of the main air pipe is connected to an air outlet of the silencing box 10. The silencing nozzle 20 is arranged at air inlets of the airbags. The silencing nozzle is of a circular arc structure, which avoids noise generated by right-angle collisions between airflows in the existing art and greatly reduces noise of the airflows.

To further improve the comfort of use of a user, the massage control system further includes a thermal therapy module. The thermal therapy module is connected to the control module and includes a waist heating pad 81 and a foot heating pad 82, so that the user can enjoy thermal therapy while enjoying massage.

The mattress 1 includes an upper layer 12, a middle layer 13, and a lower layer 14. The middle layer 13 has memory foam 131 and support sponge which are distributed vertically. The back airbag group 4, the waist airbag group 5, the hip airbag group 6, and the leg airbag group 7 are arranged below the memory foam 131. When each airbag is inflated, a corresponding part of the memory foam 131 can be jacked up, thus achieving a massage effect. The support sponge is divided into soft sponge 132 and hard sponge 133 which are distributed vertically to provide a support force for each airbag group.

The waist heating pad 81 and the foot heating pad 82 are arranged on an upper surface of the upper layer 12. Meanwhile, heat insulation pads are arranged on lower surfaces of the waist heating pad 81 and the foot heating pad 82 to avoid downward heat transfer.

A groove 1311 is formed in a lower surface of the memory foam 131; and the branch air pipes in the control air path are arranged in the groove 1311, thus preventing the problem that the memory foam 131 presses the air pipes, which affects the circulation of the airflow. Two branch air pipes connected to the neck airbag group 3 are connected to the left airbags 31, the right airbags 32, and the bottom airbags 34 after passing through the middle layer 13, the upper layer 12, and the pillow 2. The left airbags 31 and the right airbags 32 are connected to the same branch air pipes.

A mounting room is arranged at a position, close to a bed position, in the lower layer. The mounting room is configured to mount components such as the air pump 9, the control module, the valves, and the silencing box 10.

During specific operation, a control command of the remote controller 50 is transmitted to the signal receiving module in the mattress 1 through the wireless module. Then, the preset program of the micro control unit in the mattress 1 is started, and the micro control unit controls the air pump 9 to blow air and opens the valves at the same time. The air pump 9 blows air into the silencing box 10 and then blows the air into the airbags through the main air path and the valves of the branch air paths 40. After a period of time, the micro control unit controls the valves to be closed. In this case, due to the gravity of a human body, the air in the airbags is dissipated from the valves. In this case, an air pressure inside the silencing box 10 begins to increase, and the micro control unit controls the valves to be opened. The air pump 9 starts to inflate the airbags for the second time for sequential circulation.

Based on the above structure, the present disclosure can achieve a single-key massage function and a cyclic massage function. The single-key massage function is to control the neck airbag group 3, the back airbag group 4, the waist airbag group 5, the hip airbag group 6, and the leg airbag group 7 separately, and only massage parts of a user that are required to be massaged. During operation, the user can activate a corresponding massage function by pressing a corresponding single-key massage function. The cyclic massage function is to simultaneously control the neck airbag group 3, the back airbag group 4, the waist airbag group 5, the hip airbag group 6, and the leg airbag group 7. After the user presses the cyclic massage function, the airbag groups run and perform massaging based on the preset program in the micro control unit.

The above descriptions are only preferred embodiments of the present disclosure, and the scope of protection of the present disclosure is not limited to the above embodiments. Any technical solution belonging to the concept of the present disclosure belongs to the scope of protection of the present disclosure. It should be noted that a person of ordinary skill in the art may make several improvements and modifications without departing from the principle of the present disclosure. These improvements and modifications shall fall within the scope of protection of the present disclosure.

What is claimed is:

1. Multi-valve multi-airbag massage equipment, comprising a massage control system and a mattress,
wherein the massage control system comprises a user command module, a signal receiving module, a control module, and an execution module;
the user command module is configured to generate a control command in response to a user operation;
the signal receiving module is connected to the user command module to receive the control command;
the control module is connected to the signal receiving module and generates a control signal based on the control command;
the execution module comprises an air pump, a control air path, and a plurality of massage airbag groups;
the air pump is connected to the control module and performs start and stop operations after receiving the control signal;
the control air path is connected to the control module and the plurality of massage airbag groups, and is connected or disconnected after receiving the control signal to inflate or deflate the plurality of massage airbag groups; and
the plurality of massage airbag groups are respectively arranged in the mattress and above a position, corresponding to a bedside, on the mattress.

2. The multi-valve multi-airbag massage equipment according to claim 1, wherein a plurality of massage airbag groups located in the mattress comprise a back airbag group, a waist airbag group, a hip airbag group, and a leg airbag group; a massage airbag group located above the position, corresponding to the bedside, on the mattress is a neck airbag group; and each airbag group comprises a support pad, and a left airbag and a right airbag which are arranged on the support pad.

3. The multi-valve multi-airbag massage equipment according to claim 2, wherein a pillow is arranged above the position, corresponding to the bedside, on the mattress, and the neck airbag group is arranged in the pillow.

4. The multi-valve multi-airbag massage equipment according to claim 2, wherein a bottom airbag is arranged in each of the neck airbag group and the waist airbag group; and the bottom airbags are arranged below the left airbags and the right airbags.

5. The multi-valve multi-airbag massage equipment according to claim 4, wherein the waist airbag group further comprises a middle airbag, and the middle airbag is arranged between the left airbags and the right airbags.

6. The multi-valve multi-airbag massage equipment according to claim 1, wherein the control air path comprises an air path control box and a plurality of branch air paths connected to the air path control box;
the air path control box is connected to the air pump;
air inlet ends of the plurality of branch air paths are connected to the air path control box; and air outlet ends are correspondingly connected to the plurality of massage airbag groups respectively.

7. The multi-valve multi-airbag massage equipment according to claim 1, wherein the massage control system further comprises a silencing module; the silencing module comprises a silencing box and a silencing nozzle; the silencing box is arranged at an air outlet of the air pump; and the silencing nozzle is arranged at air inlets of the massage airbag groups.

8. The multi-valve multi-airbag massage equipment according to claim 1, wherein the massage control system further comprises a thermal therapy module; and the thermal therapy module is connected to the control module and comprises a waist heating pad and a foot heating pad.

9. The multi-valve multi-airbag massage equipment according to claim 2, wherein the mattress has an upper layer, a middle layer, and a lower layer; the middle layer comprises memory foam and support sponge which are distributed vertically; the back airbag group, the waist airbag group, the hip airbag group, and the leg airbag group are arranged below the memory foam.

10. The multi-valve multi-airbag massage equipment according to claim 9, wherein a groove is formed in a lower surface of the memory foam; and a branch air pipe in the control air path is arranged in the groove.
